(19) United States
(12) Patent Application Publication
(10) Pub. No.: US 2011/0276217 A1
(43) Pub. Date: Nov. 10, 2011

(54) Hard Landing Report Based on Sink Rate Algorithm

(75) Inventors: Daniel T. Sim, Everett, WA (US); Monte R. Evans, Everett, WA (US); Jack S. Hagelin, Woodinville, WA (US); Maarten Kattouw, Everett, WA (US); Amy H. Lee, Everett, WA (US); John D. Anderson, Auburn, WA (US); Melville D.W. McIntyre, Bellevue, WA (US)

(73) Assignee: THE BOEING COMPANY, Irvine, CA (US)

(21) Appl. No.: 12/776,464

(22) Filed: May 10, 2010

(51) Int. Cl. G06F 19/00

(52) U.S. Cl. 701/29

(57) ABSTRACT

A system and a method for detecting a hard landing or other high load event of an aircraft and then automatically triggering a report of such hard landing event. A sink rate algorithm is used to estimate the altitude rate of a main gear. The sink rate algorithm uses a plurality of flight parameters to estimate the main gear altitude rate, preferably including at least the following: pitch altitude, radio altitude, vertical acceleration, body pitch rate and vertical speed. This invention has the potential to reduce the number of unnecessary structural inspections, and may also limit the scope of any such required inspections.

### BACKGROUND

This invention generally relates to aircraft maintenance and, more particularly, to a system and a method for detecting hard or heavy aircraft landings.

Hard or heavy landings are significant high load events that may adversely impact airframe structural integrity. Such landings may result in damage that affects the ability of the aircraft to fly safely. When this happens, repairs must be performed prior to flying the aircraft again. An inspection must be performed when there is a hard landing, so as to determine if such repairs are needed.

However, the inspection process that is required to assess the potential for damage due to a suspected hard landing event is undesirably time consuming. Further, the inspection process frequently results in a finding of no damage. In the past, studies showed that up to 90% of pilot-initiated hard landing inspections resulted in no finding of damage.

Although pilots attempt to be realistic about the need for inspections, the fact that people's lives are at stake creates a strong bias in favor of safety. The results of performing unnecessary inspections include undesirably increased labor costs and lost revenues due to the down time of the aircraft.

One existing system uses the load factor provided by an air data inertial reference unit (ADIRU), which is not reliable due to the body-bending response in the fuselage at touchdown. The ADIRU is located at the forward section of the fuselage and the load factor is mathematically translated to the airplane's center of gravity to determine the load factor value. Data analyses of actual landings from operators have shown that the load factor is an unreliable indicator of a hard landing event.

More specifically, the indication of a hard landing as reported within an airplane condition monitoring function (ACMF) is based on data recorded from nose-mounted accelerometers, combined and recalculated to correct for the true location of the aircraft's center of gravity. This prior art method, based on nose-located accelerometers, has been shown to produce false reports from computational errors resulting from flexure bending of longer aircraft fuselage configurations. A false report of a hard landing can result in an unnecessary costly structural inspection and has the potential to delay dispatch of the airplane.

As hard landing reports necessitate landing gear structural inspections, and incur both associated costs and potential delays in dispatch of the aircraft, an improved method for the reliable determination of a hard landing event is desirable.

### BRIEF SUMMARY

The present invention is a system and a method for determining whether a hard landing has occurred with improved dependability. The disclosed system and method employ a sink rate algorithm that estimates the vertical sink rate of the main landing gear relative to the ground both before and after the point of touchdown. [As will be explained in more detail below, the term “point of touchdown” refers to the moment in time when the first main gear truck begins to untilt.] The system generates a clean vertical sink rate value separate from the main flight control computer results, although the same conditional flight sensors, such as the radio altimeter, inertial reference units, pitch rate, and pitch attitude, are accessed and modified to account for the fact that the landing gear position is offset relative to the aircraft center of gravity.

The sink rate algorithm comprises a second-order complementary filter followed by a lag time noise reduction (i.e., smoothing) filter. The output main gear vertical sink rate takes into account the landing gear position with respect to the runway surface. Activation of the sink rate computation occurs at some preset elevation (e.g., 200 feet) above ground level of the wheel carriage as determined by the radio or radar altimeter. Monitoring continues until a predetermined time (e.g., 2 second) after the point of touchdown.

Recorded values are presented in a new baseline sink rate report for data analysis and validation of any hard landing occurrence, and to determine if there is a need for a maintenance inspection of the landing gear structure. In accordance with a further aspect, if the sink rate algorithm produces an estimated sink rate of the main landing gear that exceeds a warning threshold, an indication or report is produced, indicating that a hard landing may have occurred. More specifically, if the estimated main gear sink rate exceeded the baseline vertical sink descent rate as translated into high induced dynamic landing gear structural input loads at runway contact, a hard landing report (also referred to herein as a “landing exceedance report”) is automatically created and then transmitted to various locations.

Other aspects of the invention are disclosed and claimed below.

### BRIEF DESCRIPTION OF THE DRAWINGS

FIG. 1 is a high-level block diagram showing the main components of a system for estimating a main gear sink rate (also referred to herein as “main gear altitude rate”) in accordance with one embodiment of the invention.

FIG. 2 is a diagram showing the spatial relationship of FIGS. 2A-2D, which appear on separate sheets.

FIGS. 2A-2D are drawings which, when placed side by side, depict respective portions of a flowchart representing computations performed by a method for determining a main gear sink rate in accordance with the disclosed embodiment.

### DETAILED DESCRIPTION

The embodiments of the invention disclosed herein comprise an airplane condition monitoring function (ACMF) hosted on an Airplane Information Management System (AIMS). The AIMS is a general purpose computer that hosts many software applications. The ACMF in the disclosed embodiments comprises various software applications (hereinafter referred to as “logic units”). As will be disclosed in more detail hereinafter, one logic unit of the ACMF calculates a sink rate parameter at 20 Hz, and another logic unit of the ACMF triggers a sink rate report on every landing. A third logic unit of the ACMF triggers a hard landing report if certain preconditions have been satisfied. Although the present invention may be implemented in software running on a general purpose computer, other embodiments may be implemented in software residing on customized processors or line replaceable units (LRUs).

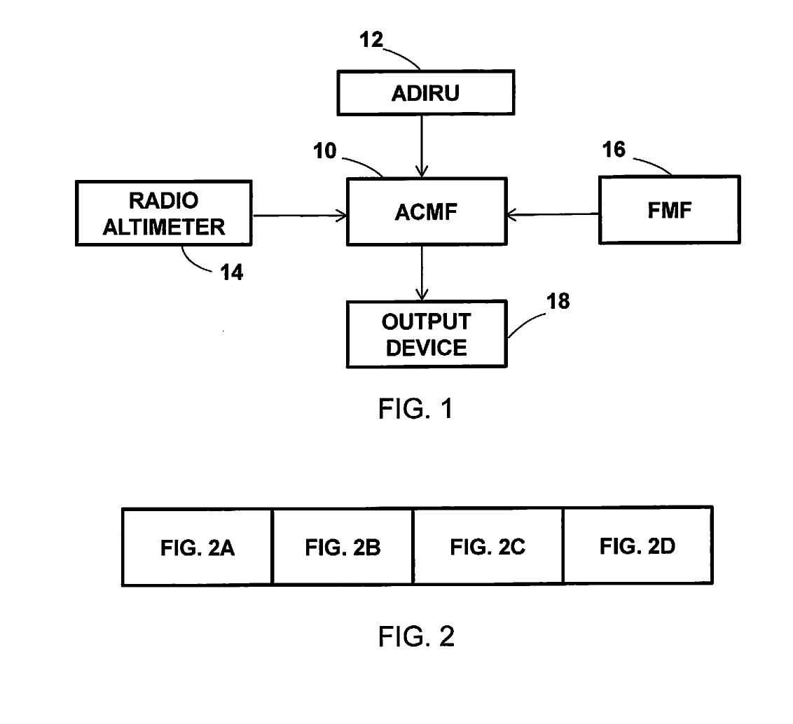

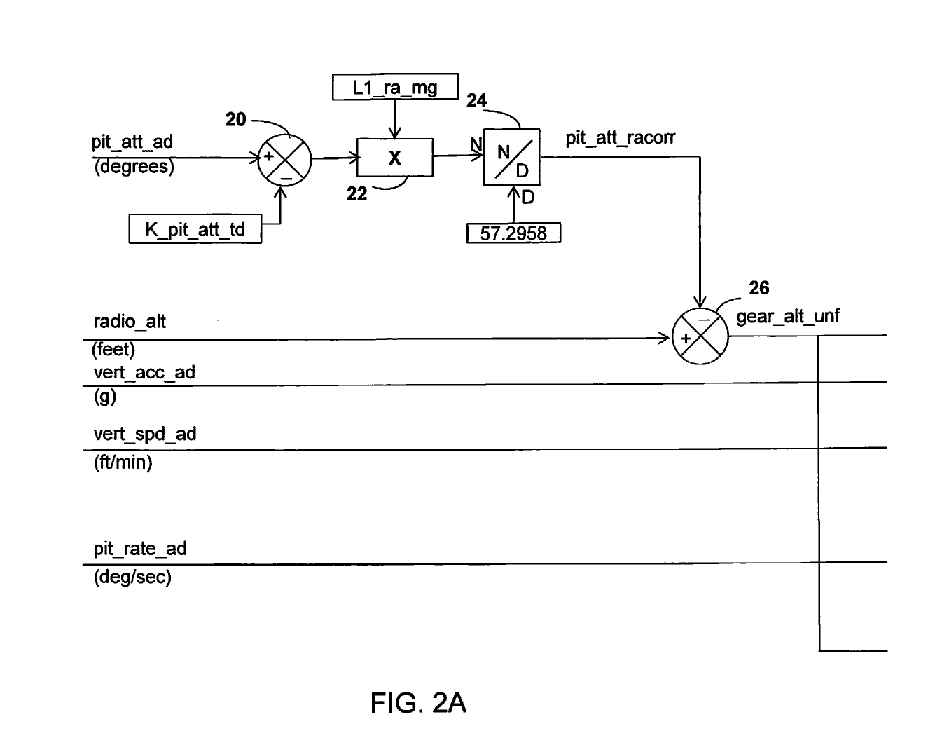

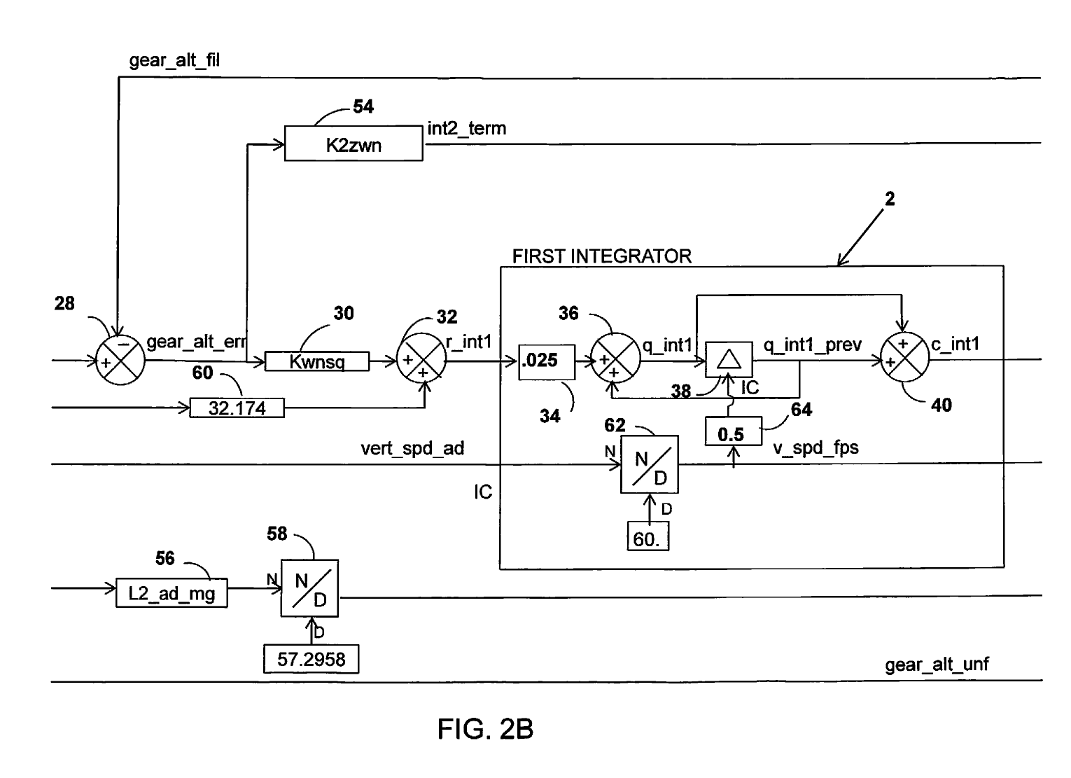

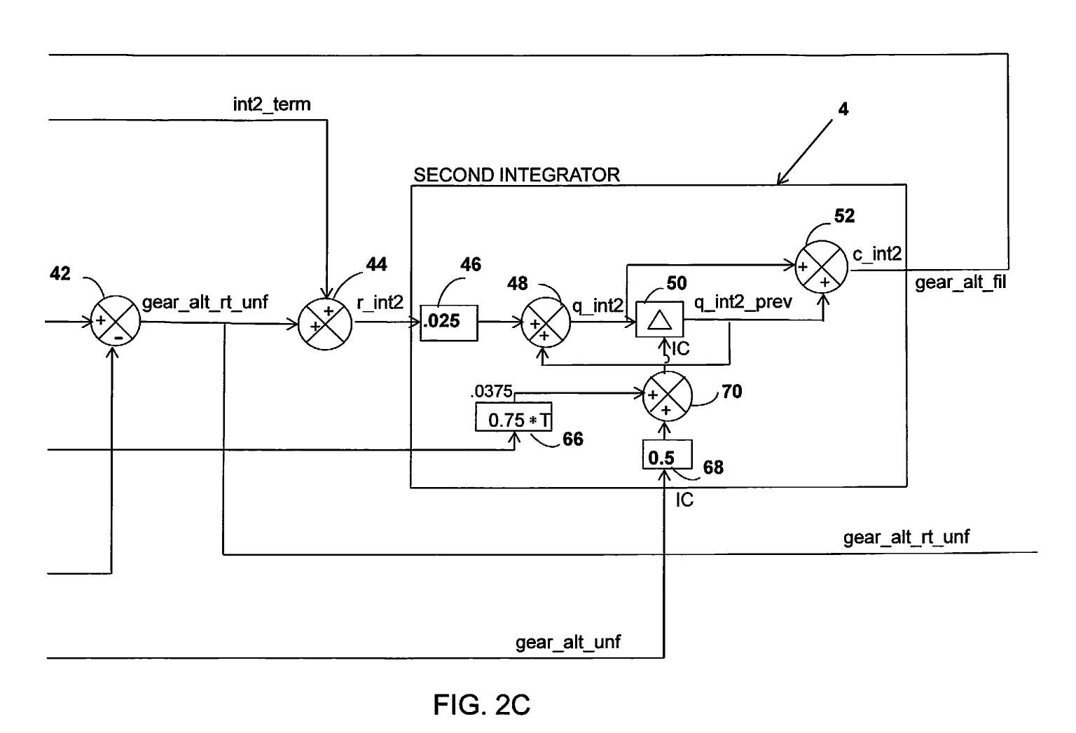

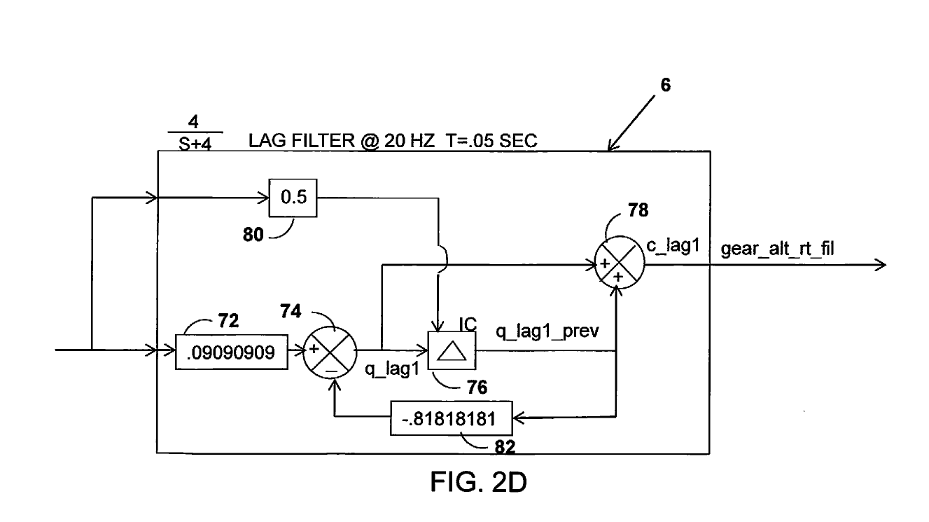

FIG. 1 shows the main components of a hard landing detection system in accordance with one embodiment of the invention. The ACMF 10 comprises a logic unit for performing the steps of a sink rate algorithm, such as the algorithm depicted in FIGS. 2A-2D. The sink rate algorithm outputs a main gear sink rate in response to the inputting of the following parameters: (1) radio altitude (in feet; + is up); (2) pitch attitude (in degrees; + is nose up); (3) body pitch rate (in deg/sec; + is nose up); (4) vertical speed (feet/min; + is up); and (5) vertical acceleration (g; + is up). The ACMF 10 receives radio altitude data from a radio altimeter 14, which is mounted on the airplane. The ACMF 10 receives data representing values of the other four parameters from an ADIRU 12. As will be explained in more detail later, the ACMF also receives data representing the current gross weight of the airplane from a flight management function (FMF) 16. The gross weight of the airplane varies over time due to the consumption of fuel during flight. The FMF 16 also comprises software that runs on the same general purpose computer on which the ACMF resides.

The ACMF 10 also receives and stores data samples of many other flight parameters, such as roll angle, roll rate, wind direction, wind speed, true heading, groundspeed, CGBRM acceleration and calibrated airspeed (CAS). This data is available for inclusion in a triggered report, along with pitch attitude, pitch attitude rate, radio altitude, vertical speed, vertical acceleration (ADIRU), and the outputs of the sink rate algorithm (i.e., filtered main gear radio altitude and main gear sink rate).

The ADIRU is transmitting the data and ACME is receiving it. The transmit rate depends on what data is sought. The vertical acceleration and pitch attitude are transmitted by the ADIRU at 40 Hz, but the ACMF is limited to a maximum acquisition rate of 20 Hz. The pitch attitude rate is transmitted by the ADIRU at 20 Hz.

The ACMF provides a programmable method for triggering custom data reports. Report triggers are defined using logic units to collect sample data at a predefined rate and time prior to and after the trigger event. Reports are defined using a Ground Based Software Tool (GBST), which provides the basic framework to support Airline Modifiable Information (AMI) development.

The data samples are only temporarily stored in memory (of the AIMS computer) for the duration of the largest amount of history samples specified in the AMI. This is referred to as the History Buffers. If the data is not used by any report within the maximum history range, the samples are lost. Once a sample or samples are collected for a report, they are permanently stored with the report.

A report collects a set (or multiple sets) of data under certain conditions, such that the user can see these set(s) of data at a later time (long after the conditions of interest have passed). The sink rate report collects two sets of data: (1) the report header data (a single snapshot of documentary data which includes aircraft ID, Date/Time, Flight Number, Departure and Arrival Station, Software ID, etc.); and (2) the set of sink rate data, which collects time-series data from 15 samples prior to a trigger event (i.e., the truck tilt transition from Tilt to Not-Tilt) through the current time of the trigger event. In order to collect this data, the report must be activated or, as referred to herein, opened.

The different sets of data to be collected (a snapshot of header data and the time-series of sink rate data) are referred to herein as data collection groups. In general, reports can collect many different sets of data and not all sets need to be collected at the same time. When the main trigger event occurs and the first set(s) of data need to be collected is when the report is opened and it starts collecting the first set(s) of data. Other set(s) of data may need to be collected at a later time or at the occurrence of additional trigger conditions. When the appropriate time has passed or the additional triggers occur, these data sets (data collection groups) are activated to collect their data, which is referred to as “initiating” the data collection group. It so happens that in the sink rate report both sets of data (header and sink rate data) are collected at the same time, which is also the time when the report is opened.

The sink rate algorithm disclosed herein has application for reporting hard landings by aircraft of different types. In particular, the sink rate algorithm disclosed herein has been adapted for use with models 200 and 300 of the Boeing 777 aircraft. Certain parameters which appear in the algorithm disclosed hereinbelow have values which vary depending on whether the airplane is a 777-200 or a 777-300. Such parameters include L1, L2 and pit_at_td, which are defined as follows: L1 is the distance from the radio altimeter antenna to the main gear and has values of 63.1 ft for the 777-200 or 80.6 ft for the 777-300; L2 is the distance from the ADIRU to the main gear and has values of 87.9 ft for the 777-200 or 105.4 ft for the 777-300; and pit_at_td is the nominal pitch attitude (in degrees) at touchdown and equals 5.3 deg for the 777-200 or 4.15 deg for the 777-300. However, the sink rate algorithm disclosed below is not limited to use with Boeing 777 aircraft and can be applied to other aircraft by substituting the appropriate values for the parameters L1, L2 and pit_at_td corresponding to such other aircraft models.

The sink rate algorithm disclosed herein is based on a design that has been widely used in autopilots. It combines information from radio altimeters, inertial reference units, pitch rate and pitch attitude, to form an estimate of the sink rate of the main gear relative to the ground. The sink rate output is smoothed with a quarter-second time constant lag filter to provide a clean, well-behaved estimate of the sink rate during flare and touchdown. This algorithm is currently being used within Flight Controls on the 777 because of its accuracy, but it is not available to the rest of the airplane systems. In accordance with the present invention, the sink rate algorithm has been recreated in the ACMS for use in automatically generating reliable hard landing reports.

It is not possible to simply measure the vertical speed at the time of landing to detect a hard landing event. On the Boeing 777 aircraft, the vertical speed as measured by the ADIRU 12 is corrupted when the airplane approaches the ground due to changes in static pressure. Also, if the output of the radio altimeter 14 were differentiated, the resulting parameter would be very noisy.

Using the vertical acceleration parameter to calculate sink rate has an advantage over using the vertical speed in that the vertical acceleration is not corrupted by ground effects as the airplane nears the ground. However, on the Boeing 777 aircraft, the vertical acceleration parameter by itself is not appropriate for determining hard landings. Especially on the 777-300 airframe, use of the vertical acceleration parameter would lead to very high G readings for landings that are not considered hard landings. The vertical acceleration parameter is measured by the ADIRU 12 (see FIG. 1) in the EE-bay (far forward from the main gear or the center of gravity), subjecting it to significant errors due to pitch attitude, pitch attitude rate and airframe bending characteristics.

Use of the “Center of Gravity Body Normal Acceleration” (CGBRMACL) parameter instead of vertical acceleration provides slightly better results, but still leads to high G readings, especially on the -300/-300ER airframe.

Disclosed herein is a better method to aid in the investigation into reported hard landings using an estimated sink rate of the main gear. The system disclosed herein determines and provides a reliable indication or report of a landing that may have exceeded the baseline vertical sink descent rate as translated into high induced dynamic landing gear structural input loads at runway contact. The new indication or report is provided in response to the generation of a main gear sink rate value above a predefined threshold. The output vertical sink rate takes into account the main landing gear position with respect to the runway surface. Activation of the sink rate computation occurs at some preset elevation (e.g., 200 feet) above ground level of the wheel carriage (hereinafter “wheel truck”), as determined by the radio or radar altimeter. Monitoring continues until a predetermined time (e.g., 2 seconds) after the point of touchdown.

The Baseline ACMF AMI utilizes the following components to provide the main gear sink rate parameter to the operator.

The ACMF comprises a logic unit that calculates the sink rate parameter at 20 Hz. The sink rate is the actual main landing gear sink rate (in ft/sec) based on radio altitude, filtered and corrected for pitch attitude, pitch attitude rate, vertical speed, vertical acceleration and airframe-specific (e.g., 777-200/-300) body bending characteristics, using a sink rate algorithm.

The ACMF also comprises a logic unit that triggers the sink rate report. This logic unit triggers the sink rate report on every landing to make the sink rate data available to the operator. This is not a hard landing report, but rather a routine recording of the sink rate data. If the aircraft crew reports a hard landing, the data in the sink rate report can be used as an aid in reviewing that landing. The sink rate report contains the input and output parameters of the sink rate algorithm and some additional landing-related parameters. Sample sink rate reports are presented in Section 1 of the Appendix, including a sample sink rate report for MAT Display/Disk/Printer from the GBST, showing the report format, and a sample report as generated during a laboratory test, showing data values.

As seen in Section 1 of the Appendix, the sink rate report contains the sink rate parameter and other landing-related data. This particular exemplary report provides the sink rate parameter (SNKRAT) and related parameters at 20 Hz from 15 samples (0.75 sec) prior to first main gear touchdown through main gear touchdown. The other parameters listed in the report data table are as follows: SEC—data acquisition time (in seconds prior to touchdown); RH—radio height (altitude) as measured by the radio altimeter; PITCH—pitch angle as measured by the ADIRU; PTCHRAT—pitch rate angle as measured by the ADIRU; VERTACC—vertical acceleration as measured by the ADIRU; ALTFILT—filtered gear altitude as calculated by the sink rate algorithm; SNKRAT—filtered gear altitude rate as calculated by the sink rate algorithm; ROLL—roll angle as measured by the ADIRU; TT—main gear truck tilt as measured by a sensor; FG—fail to ground discrete indicator that a main gear is on the ground and a predefined weight has been placed on the gears. The TT and FG parameters are explained in more detail and the term touchdown is defined in the next paragraph.

Each main gear on the Boeing 777 aircraft has three axles for a total of six wheels. These axles are attached to a platform, called the “truck”, which in turn is attached to a vertical beam extending downward from the aircraft body. The truck with three axles is attached to the vertical beam in such a manner that it can pivot about an axis parallel to the axles. On the ground, this allows the wheels to follow the contours of the ground. In the air, the wheel truck will pivot in such manner that the rear wheels are hanging lower than the front wheels (i.e., the truck is tilted). On the Boeing 777 aircraft, when the gear is pressurized and tilted up in preparation for landing, the amount of truck tilt is about 12 deg. Upon landing, the rear wheels will touch down first; as the aircraft continues to descend, the truck will pivot until the truck is approximately horizontal and all wheels are touching the ground. There is a sensor that tells the ACMF when the truck is tilted more than 9 deg (TT=2) and when it is tilted less than 9 deg (TT=1). More specifically, this sensor will go false, indicating the trailing tires have touched the ground, when the amount of tilt decreases by about 3 deg, i.e., to the 9 deg tilt position. (A person skilled in the art will recognize that the sensor could be designed to transition at a different tilt angle.) The point of touchdown, as defined herein, is when the first main gear truck tilt transitions from TT=2 to TT=1 i.e., first main gear touchdown. If the aircraft is flying perfectly level and the ground is perfectly level, both left and right main gears will touch down at the same time. If the aircraft is slightly rolled to the left or the right, one gear will touch down before the other. In the sink rate report with data values shown in Section 1 of the Appendix, the values “12” in the “TT” column indicate that the left main gear truck is not tilted while the right main gear truck is tilted.

The truck tilt indication is sampled at 10 Hz by the ACMF, but the maximum delay in the signal is 700 msec. That is why the data in the baseline sink rate report is recorded from −0.75 sec through 0 sec. When the truck tilt position changes from >9 deg to <9 deg, the report will show the transition from TT=2 to TT=1 with a possible maximum delay of 700 msec after the actual event. Since the data is being recorded in the report with a 750-msec history, the ACMF will always capture the actual event and the maximum sink rate in the report data, although one cannot be certain where in the last 700 msec the event actually occurred. If the maximum sink rate limit was exceeded anywhere in the last 700 msec, it should be assumed that it was a hard landing.

The “Fail-to-Ground” (FG) column in the sample sink rate report (see Section 1 of the Appendix) is another indication of the aircraft being on the ground or in the air. Fail-to-Ground is true (on ground) when either the left or right main gear is on the ground. This indication is slightly different from the Truck Tilt indication as it requires more weight on the gear. When the Truck Tilt transition occurs, there is virtually no weight on the gears; as the aircraft continues to descend and decelerate, more and more weight is placed on the gears; and as the gears compress enough (similar to a shock absorber on a car), one will see the Fail-to-Ground discrete transition. [The second sample report in Section 1 of the Appendix presents simulation data indicating that the FG discrete transition occurs before the truck is no longer tilted. The supplied report was generated in a laboratory, which may not have simulated this data entirely correctly. In the real world, FG=1 will occur after TT=1.]

The ACMF opens the baseline sink rate report if any one of the following conditions has occurred: (1) the last two samples of the left main landing gear truck tilt (LMLGTT_PSEU1) are valid AND the LMLGTT_PSEU1 transitioned from a value of 2 (truck tilted) to a value of 1 (truck not tilted); OR the last two samples of the right main landing gear truck tilt (RMLGTT_PSEU2) are valid AND the RMLGTT_PSEU2 transitioned from a value of 2 (truck tilted) to a value of 1 (truck not tilted). In short, the report is opened upon the first main landing gear transition from Tilt to Not Tilted.

As previously disclosed hereinabove, the system also provides a hard landing (or landing exceedance) report in response to the sink rate algorithm outputting a main gear sink rate value that exceeds a predefined threshold. A sample landing exceedance report appears in Section 2 of the Appendix. The vertical acceleration (VERT G), pitch attitude (PITCH), vertical speed (VERT SPEED), radio height (RADIO ALT), and pitch attitude rate (PITCH RATE) are monitored at a rate of 20 Hz by the same logic unit previously described. These parameters are used to compute the actual sink rate at 20 Hz using the same sink rate algorithm previously described. The actual sink rate (RALT RATE FILT in the sample report) is computed from a radio altitude of 200 ft through roll-out. The point of touchdown is determined by the first main gear truck tilt (LMLGTT/RMLGTT) transitioning from Tilted (=2) to Not-Tilted (=1). The main gear truck tilt is monitored at a rate of 10 Hz. The roll angle is monitored at a rate of 10 Hz. The landing exceedance (i.e., hard landing) report is triggered if, at the time of touchdown, the following conditions are satisfied: (A) the roll angle is between −2 and +2 degrees AND the roll rate is between −3.0 and +3.0 deg/sec AND the current or preceding sample of the actual sink rate exceeds 8 ft/sec; OR (B) the roll angle is less than −2.0 or greater than +2 degrees OR the roll rate is less than −3.0 or greater than +3 deg/sec AND the current or preceding sample of the actual sink rate exceeds 6 ft/sec.

Alternatively, the landing exceedance report is triggered if the gross weight of the airplane exceeds a predefined threshold. The Flight Management Function (FMF) broadcasts actual gross weight on a databus. The ACMF simply reads the data from the bus. Generally actual gross weight is entered by the crew before the flight, after taking on fuel. The FMF then takes that value and continuously deducts the weight of the fuel burned. The actual gross weight of the aircraft at the point of touchdown (GROSS WEIGHT TD VALUE field in the sample report in Section 2 of the Appendix) is checked at a rate of 1 Hz against the airframe-specific maximum landing weight (GROSS WEIGHT LIMIT field in the sample report) and if the limit is exceeded, the landing exceedance report is triggered. The maximum landing weight (MLW) is dependent on the airframe (-200, -200LR, -300, -300ER, etc.) and varies from 441,000 to 575,000 lbs. The logic unit that triggers the landing exceedance report determines which airframe it is installed on and selects the appropriate MLW. The GROSS WEIGHT LIMIT field in the sample report shown in Section 2 of the Appendix contains a number representing which MLW the logic unit has selected.

The landing exceedance report collects data at 20 Hz from 3 seconds prior through 2 seconds after the point of touchdown. The data collected includes vertical acceleration, radio altitude, vertical speed, aircraft speed, true heading, pitch, pitch rate, roll, roll rate, CGBRM acceleration, landing gear and control surface data as well as wind speed and wind direction. The report also includes outputs from the sink rate algorithm, namely: main gear altitude (RALT FILT in the sample report) and main gear sink rate (RALT RATE FILT in the sample report).

The landing exceedance report data also includes the main gear sink rate and aircraft gross weight at the point of touchdown (SINKRATE TD VALUE and GROSS WEIGHT TD VALUE), the peak center-of-gravity body normal acceleration (PEAK CGBRMACL) over a 2-second period from first main gear touchdown, and the peak pitch rate (PEAK PITCH RATE) at nose gear touchdown. The report also includes the reason why the landing exceedance report was triggered (either because the sink rate limit or the gross weight limit was exceeded at touchdown or both).

In summary, the baseline sink rate report is opened or triggered at touchdown for each landing, whereas the landing exceedance (i.e., hard landing) report is opened or triggered at touchdown only when the trigger preconditions corresponding to a suspected hard landing have been satisfied. In either case, the sink rate algorithm starts to operate prior to touchdown, e.g., when the aircraft reaches a predefined radio altitude, and continues to operate for a time period after touchdown, e.g., through roll-out. For each report, data is collected and formatted in response to the trigger event. The collected data in report format is both stored in the memory of the AIMS computer and sent to one or more output devices.

Referring back to FIG. 1, upon the trigger preconditions being satisfied, either report will be sent by the ACMF 10 to an output device 18. The output device 18 may be any one of the following five output devices: MAT display, MAT disk, printer, QAR and/or Datalink. The acronym “MAT” stands for the Maintenance Access Terminal. The 777 aircraft can have multiple MATs installed on the aircraft depending on the configuration selected by the operator. Additionally, there are PMATs (portable MATs) that can be plugged into the system at various locations throughout the aircraft. ACMF is one of the many systems that can be accessed through the MAT/PMAT. The MAT has a display that allows the user to enter data and/or display data from the various systems. The MAT also has a 3.5″ floppy disk drive (as well as a built-in hard disk drive) through which the user can dataload the AIMS cabinet/functions or download data from the various functions. Reports from ACMF can be downloaded to the floppy disk in the MAT. The acronym “QAR” is the Quick Access Recorder, which is a device dedicated to the ACME. The ACMF can record ARINC-717 data to the QAR (similar to a flight data recorder) as well as record formatted reports as ASCII files (RS-422 interface). Datalink is a function that allows data from various system to be downlinked from the aircraft to the ground via either VHF or HF radios or though a satellite link. The ACMF has access to this media as well to downlink (short) reports to the ground. These devices are part of the aircraft system, not part of the ACMF. The ACMF is just one of the many functions with access to these I/O devices. The QAR is also not part of the ACMF, but the ACMF is the only function that has the necessary I/O hardware and software needed to access this device and the QAR is dedicated to ACMF only.

Referring to FIG. 2 and its component parts (FIGS. 2A-2D), the estimated main gear sink rate is calculated based upon the following inputs to the sink rate algorithm (see FIG. 2A): vertical acceleration from the ADIRU (vert_acc_ad); vertical speed from the ADIRU (vert_spd_ad); pitch attitude from the ADIRU (pit_att_ad); pitch attitude rate from the ADIRU (pit_rate_ad); and the radio altitude from the radio altimeter (radio_alt). The sink rate algorithm comprises a second-order complementary filter, comprising a first integrator 2 (seen in FIG. 2B) and a second integrator 4 (seen in FIG. 2C), and a lag time noise reduction (i.e., smoothing) filter 6 (seen in FIG. 2D), which is a third integrator. The output of the second integrator 4 is the main gear altitude (gear_alt_fil). The output of the lag filter 6 is the main gear sink rate (gear_alt_rt_fil). The time constant of the lag filter 6 must not be excessively long, else the output will read erroneously high sink rates at touchdown. In the particular embodiment shown in FIG. 4D, a time constant of 0.25 sec was chosen.

An important issue with the sink rate algorithm is addressing the question of how to implement the three integrators. Any standard method would be acceptable, including simple rectangular (Euler) integration. In the particular embodiment shown in FIGS. 2A-2D, a Tustin algorithm for implementing integrators and the lag filter was chosen. The integration methods all require knowledge of the rate at which the algorithm will be run. In the disclosed embodiment, a rate of 20 Hz was chosen, leading to a frame time of 50 msec. In order to maintain desired fidelity, the flight parameters may be recorded at other sample rates provided they enable accurate resolution of the parameter values that occurred prior to and subsequent to touchdown.

The sink rate algorithm will now be described in detail with reference to FIGS. 2A-2D. The algorithm is programmed in LAMA code, which was created by Honeywell for programming ACME AMI software. The pseudo code for the sink rate computations depicted in FIGS. 2A-2D are presented in Section 3 of the Appendix. This software is executed in real time. The code runs every 50 msec to derive successive main gear sink rate values from the data samples received from the ADIRU (pitch attitude, pitch attitude rate, vertical speed, vertical acceleration) and from the radio altimeter (radio height or altitude). The first time the code runs, initialization values are used by the first and second integrators 2, 4 and the lag filter 6. Each time the code runs thereafter, the integrators and lag filter use the respective previous values q_int1_prev, q_int2_prev and q_lag1_prev.

Referring to FIG. 2A, the first task of the sink rate algorithm is to correct the radio altitude signal (radio_alt) received from the radio altimeter using a pitch attitude signal (pit_att_ad), which is readily available from the ADIRU. This correction is required to make the radio altitude read 0.0 ft when the trailing tires of the main gear touch the ground during landings that do not occur with pitch attitude right at the nominal landing touchdown attitude. In step 20, the nominal pitch attitude at touchdown (K_pit_att_td) is subtracted from pitch attitude signal (pit_att_ad). In step 22, the result of step 20 is multiplied by the parameter L1_ra_mg (previously defined). The product of step 22 is then divided (step 24) by the constant 57.2958 to arrive at a parameter named pit_att_racorr, which is the pitch attitude radio altimeter correction term [CCC 1) in Appendix, §3]. This correction term is subtracted from the radio altitude signal (radio_alt) in step 26 to compute the parameter gear_alt_unf, which is the unfiltered main gear altitude [CCC 2) in Appendix, §3]. The parameter gear_alt_unf will be an input to the second integrator (see FIG. 2C), which will be discussed in detail later. As seen in FIG. 2B, it is also one of two parameters that will be operated on in step 28.

In Section 3 of the Appendix, the statement “if (comp_filt_ic=TRUE)” is used to flag when the sink rate filter needs to be initialized. For CCC 3), the parameters gear_alt_err, r_int1 and int2_term are all set to zero at initialization.

Referring now to FIG. 2B [and to CCC 3) in Appendix, §3], in step 28, a parameter gear_alt_fil, which is the filtered main gear_altitude outputted by the second integrator 4 (see FIG. 4C), is subtracted from the parameter gear_alt_unf to produce a main gear_altitude error parameter named gear_alt_err. In step 30, the result of step 28 is multiplied by a gain Kwnsq (equal to 9.0 (rad/sec)² for the 777-200 and 777-300) in step 30. In step 60, the vertical acceleration from an ADIRU (vert_acc_ad) is multiplied by a constant=32.174. The products of steps 30 and 60 are summed in step 32 to form the parameter r_int1, which is inputted to the first integrator 2. In step 54, the result of step 28 is multiplied by a gain K2zwn (equal to 6.0 rad/sec for the 777-200 and 777-300). The result of step 54 is a parameter int2_term.

Upon start-up of the sink rate filter, the first integrator 2 is initialized using the current value of the ADIRU vertical speed (parameter vert_spd_ad). This allows the filter to reach a stable state faster than when it is started from a zero value.

Still referring again to FIG. 2B [and to CCC 4) in the Appendix, §3], the parameter vert_spd_ad (in ft/min) is divided by a constant=60 in step 62, the result being a parameter named v_spd_fps (i.e., the vertical speed in ft/sec). The parameter v_spd_fps is multiplied by a constant=0.5 in step 64 and is also sent to the second integrator (item 4 in FIG. 2C). The result of step 64 is then used to initialize the first integrator 2. The initial values for v_spd_fps, q_int1, q_int1_prev and c_int1 inside the first integrator 2 are given in Section 3 of the Appendix [see CCC 4)].

Following initialization, the output c_int1 of the first integrator 2 is a function of the input r_int1. In step 34, the parameter r_int1 is multiplied by a constant=0.025. The product of step 34 is then summed with the parameter q_int1_prev in step 36 to produce q_int1. Step 38 is a line of code that loads the current value of q_int1 into q_int1_prev, for use the next time through the algorithm. Step 38 must occur after step 40 is done. The current values of q_int1 and q_int1_prev are summed in step 40 to produce the parameter c_int1.

Still referring to FIG. 2B [and to CCC 5) in the Appendix, §3], in step 56, the ADIRU pitch attitude rate (parameter pit_rate_ad) is multiplied by the parameter L2_ad_mg (previously defined) in step 56. The product of step 56 is then divided by a constant=57.2958 in step 58.

Referring now to FIG. 2C [and to CCC 5) in the Appendix, §3], the result of step 58 is then subtracted from the parameter c_int1 in step 42 to form a parameter gear_alt_rt_unf, which represents an unfiltered estimated main gear sink rate. This parameter is then summed with the parameter int2_term in step 44 to form parameter r_int2. The parameter r_int2 is then processed by the second integrator 4.

Still referring again to FIG. 2C [and to CCC 6) in the Appendix, §3], in step 66 the parameter vert_spd_fps is multiplied by the quantity 0.75*T, where T is the sampling interval (i.e., T=0.05 sec for the disclosed embodiment in which the sampling rate=20 Hz). Also, in step 68, the parameter gear_alt_unf is multiplied by a constant=0.5. The respective products of steps 66 and 68 are summed in step 70. The result of step 70 is then used to initialize the second integrator 4. The initial values for q_int2, q_int2_prev and c_int2 inside the second integrator 4 are given in Section 3 of the Appendix [see CCC 6)].

Following initialization, the output c_int2 of the second integrator 4 is a function of the input r_int2. In step 46, the parameter r_int2 is multiplied by a constant=0.025. The product of step 46 is then summed with the parameter q_int2_prev in step 48 to produce q_int2. Step 50 is a line of code that loads the current value of q_int2 into q_int2_prev, for use the next time through the algorithm. Step 50 must occur after step 52 is done. The current values of q_int2 and q_int2_prev are summed in step 52 to produce the parameter c_int2, which is the same as the parameter gear_alt_fil that is subtracted from the parameter gear aft unf in step 28 to arrive at the parameter gear_alt err, as previously described with reference to FIG. 2B.

The unfiltered main gear sink rate gear_alt_rt_unf (see step 42 in FIG. 2C) is inputted to the lag filter 6 shown in FIG. 2D. The lag filter 6 computes the filtered main gear sink rate gear_alt_rt_fil as a function of the input gear_alt_rt_unf. Referring now to FIG. 2D and to CCC 7) in Section 3 of the Appendix, the lag filter is initialized by multiplying the parameter gear_alt_rt_unf by a constant=0.5 in step 8 and then setting the parameters q_lag1 and q_lag1_prev equal to the product of step 80 and setting the parameter c_lag1 equal to gear_alt_rt_unf. The initial values for q_lag1, q_lag1_prev and c_lag1 inside the lag filter 6 are given in Section 3 of the Appendix [see CCC 7)].

Following initialization of the lag filter 6, the parameter gear_alt_rt_fil is multiplied by a constant=0.09090909 in step 72. The parameter q_lag1_prev is multiplied by a constant=−0.81818181 in step 82. The product of step 82 is then subtracted from the product of step 72 in step 74, thereby producing the output q_lag1. Step 76 is a line of code that loads the current value of q_lag1 into q_lag1_prev, for use the next time through the algorithm. Step 76 must occur after step 78 is done. The current values of q_lag1 and q_lag1_prev are summed in step 78 to produce the parameter c_lag1, which is the sink rate parameter gear_alt_rt_fil that is output to the logic unit that triggers the opening of a landing exceedance report if certain preconditions (previously described) have been satisfied.

The present invention provides a method and a system for detecting hard landings that is cost effective, accurate and reliable. In this manner, less reliance need be placed upon the subjective opinion of the pilot and less downtime of the aircraft is likely to result.

The hard landing detection system disclosed herein may be used to provide accurate and reliable information for use in evaluating the need for and/or level of inspection that is required due to a hard landing event. In this manner, wasteful and unnecessary inspections resulting from improperly classified landings may be avoided. Thus, both costs and downtime can be reduced while safety is maintained.

While the invention has been described with reference to various embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention.

### APPENDIX

### 1. ACMF Baseline AMI Sink Rate Report

The format of a sample sink rate report for MAT Display/Disk/Printer from the GBST is as follows:

| | | | |
|---|---|---|---|
| BCG001AS | AAAAAAAAAA | SINKRATE REPORT | NNN |

| ACID | FLT | DPT | DST | DATE | FLCT | FM | GMT | SFC |
|---|---|---|---|---|---|---|---|---|
| AAAAAAAA | AAAAAAAA | AAAA | AAAA | ZZ/ZZ/ZZ | NNNN | AA | ZZ:ZZ:ZZ | NNNNN |

| SWID | FLAP POS | GWT | ALT | RH | AGDLKD |
|---|---|---|---|---|---|
| AAAA-AAA-AAA-AA | AAA | NNNNNN | SNNNNN | SNNN.N | AAAAAAA |

TT-Main Gear Truck Tilt, 1-Not Tilt, 2-Tilt, 0&3-Inv
FG-Fail To Ground Discrete, 1-L Or R On Ground, 0-L&R In Air

| | | | | | | | | TT | FG |
|---|---|---|---|---|---|---|---|---|---|
| SEC | RH | PITCH | PTCHRAT | VERTACC | ALTFILT | SNKRAT | ROLL | LR | LR |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |
| SNN.NN | SNNN.NN | SNN.NNN | SNN.NNN | SN.NNNN | SNNN.NN | SNN.NN | SN.NN | NN | BB |

The format of a sample sink rate report as generated during a lab test is as follows:

| | | | |
|---|---|---|---|
| BCG001AS | B777-300ER | SINKRATE REPORT | 2 |

| ACID | FLT | DPT | DST | DATE | FLCT | FM | GMT | SFC |
|---|---|---|---|---|---|---|---|---|
| N7771 | DSP0922 | KBFI | KBFI | 22/09/09 | 1 | FL | 16:42:57 | 3085 |

| SWID | FLAP POS | GWT | ALT | RH | AGDLKD |
|---|---|---|---|---|---|
| 3101-BCG-00B-25 | F30 | 420960 | 44 | −1.5 | DWNLCKD |

TT-Main Gear Truck Tilt, 1-Not Tilt, 2-Tilt, 0&3-Inv
FG-Fail To Ground Discrete, 1-On Ground

| | | | | | | | | TT | FG |
|---|---|---|---|---|---|---|---|---|---|
| SEC | RH | PITCH | PTCHRAT | VERTACC | ALTFILT | SNKRAT | ROLL | LR | LR |
| −0.75 | 0.38 | 2.988 | 0.523 | 0.0400 | 1.86 | −4.49 | −3.93 | 22 | 00 |
| −0.70 | 0.25 | 3.021 | 0.531 | 0.0410 | 1.63 | −4.45 | −4.09 | 22 | 00 |
| −0.65 | 0.25 | 3.043 | 0.539 | 0.0410 | 1.44 | −4.40 | −4.19 | 22 | 00 |
| −0.60 | 0.00 | 3.076 | 0.539 | 0.0410 | 1.27 | −4.35 | −4.34 | 22 | 00 |
| −0.55 | −0.13 | 3.098 | 0.531 | 0.0420 | 1.10 | −4.29 | −4.44 | 22 | 00 |
| −0.50 | −0.38 | 3.131 | 0.523 | 0.0605 | 0.91 | −4.21 | −4.59 | 22 | 00 |
| −0.45 | −0.50 | 3.153 | 0.539 | 0.0420 | 0.71 | −4.13 | −4.69 | 22 | 00 |
| −0.40 | −0.63 | 3.186 | 0.539 | 0.0420 | 0.53 | −4.06 | −4.84 | 22 | 00 |
| −0.35 | −0.75 | 3.208 | 0.531 | 0.0488 | 0.35 | −3.99 | −4.95 | 22 | 00 |
| −0.30 | −0.88 | 3.230 | 0.531 | 0.0410 | 0.19 | −3.91 | −5.11 | 22 | 00 |
| −0.25 | −1.13 | 3.252 | 0.406 | 0.1602 | 0.03 | −3.80 | −5.21 | 22 | 00 |
| −0.20 | −1.25 | 3.285 | 0.336 | 0.2090 | −0.14 | −3.64 | −5.32 | 22 | 00 |
| −0.15 | −1.38 | 3.296 | 0.234 | 0.2051 | −0.27 | −3.42 | −5.38 | 22 | 00 |
| −0.10 | −1.38 | 3.307 | 0.172 | 0.2100 | −0.37 | −3.16 | −5.43 | 22 | 11 |
| −0.05 | −1.50 | 3.318 | 0.086 | 0.2109 | −0.42 | −2.86 | −5.46 | 22 | 11 |
| 0.00 | −1.50 | 3.318 | 0.039 | 0.2109 | −0.45 | −2.52 | −5.47 | 12 | 11 |

### 2. ACMF AMI Landing Exceedance Report

The format of a sample landing exceedance report is as follows:

| | | | |
|---|---|---|---|
| BCG002AS | B777-200 | LANDING EXCEEDANCE REPORT | 1 |

| ACID | FLT | DPT | DST | DATE | FLCT FM | GMT | SFC |
|---|---|---|---|---|---|---|---|
| N777BAC | 1234567 | KBFI | KBFI | 23/11/09 | 0 DC | 19:21:38 | 1609 |

| SWID | FLAP POS | GWT | ALT | RH | AGDLKD |
|---|---|---|---|---|---|
| 311B-BSM-MKA-02 | F5 | 390000 | 36 | −8.9 | DWNLCKD |

| | |
|---|---|
| REASON FOR REPORT: SINKRATE | EXCEEDED AT TOUCH-DOWN |

| --- SINKRATE ---- | | PEAK | PEAK |
|---|---|---|---|
| LIMIT | TD VALUE | CGBRMACL | PITCH RATE |
| −6.0 | −29.0 | 6.00 | −6.29 |

| -- GROSS WEIGHT -- | | | |
|---|---|---|---|
| LIMIT | TD VALUE | AIRFRAME | PGPIN |
| 441000 | 390000 | 777-200 | 0001 |

| | VERT | CGBRM | RADIO | VERT | | GRND | TRUE | | PITCH |
|---|---|---|---|---|---|---|---|---|---|
| SEC | G | ACCEL | ALT | SPEED | CAS | SPEED | HDG | PITCH | RATE |
| −3.00 | −0.05 | −0.05 | 68.63 | −26.23 | 212.6 | 212.4 | 125.2 | 0.4 | −0.313 |
| −2.95 | −0.05 | −0.05 | 67.63 | −26.33 | 212.6 | 212.4 | 125.2 | 0.4 | −0.313 |
| −2.90 | −0.05 | −0.05 | 66.50 | −26.38 | 212.6 | 212.4 | 125.3 | 0.4 | −0.313 |
| −2.85 | −0.05 | −0.05 | 65.50 | −26.48 | 212.6 | 212.4 | 125.3 | 0.4 | −0.313 |
| . | . | . | . | . | . | . | . | . | . |
| . | . | . | . | . | . | . | . | . | . |
| . | . | . | . | . | . | . | . | . | . |
| −0.15 | 3.77 | 0.94 | −10.50 | −22.63 | 213.4 | 212.9 | 125.7 | 0.0 | −1.617 |
| −0.10 | 5.87 | 2.15 | −10.50 | −16.58 | 213.5 | 212.9 | 125.7 | −0.1 | −2.742 |
| −0.05 | 5.95 | 3.64 | −10.75 | −5.18 | 213.5 | 212.8 | 125.7 | −0.2 | −5.180 |
| 0.00 | 3.74 | 6.00 | −10.25 | 1.35 | 213.4 | 212.5 | 125.7 | −0.3 | −6.289 |
| 0.05 | 1.59 | 6.00 | −9.75 | 6.95 | 213.4 | 212.3 | 125.7 | −0.7 | −5.742 |
| . | . | . | . | . | . | . | . | . | . |
| . | . | . | . | . | . | . | . | . | . |
| . | . | . | . | . | . | . | . | . | . |
| 1.85 | 0.03 | −0.12 | −9.75 | −0.70 | 207.6 | 207.1 | 125.7 | −1.0 | 0.000 |
| 1.90 | 0.07 | −0.09 | −9.75 | −0.67 | 207.4 | 207.0 | 125.7 | −1.0 | 0.008 |
| 1.95 | 0.13 | −0.03 | −9.75 | −0.52 | 207.3 | 206.9 | 125.7 | −1.0 | 0.023 |
| 2.00 | 0.17 | 0.01 | −9.88 | −0.35 | 207.3 | 206.8 | 125.7 | −1.0 | 0.023 |

| | | | | | | RALT | | | | |
|---|---|---|---|---|---|---|---|---|---|---|
| | | ROLL | WIND | WIND | RALT | RATE | MLGTT | | FTG | |
| SEC | ROLL | RATE | DIR | SPEED | FILT | FILT | L | R | L | R |
| −3.00 | 2.1 | 0.0 | 0.0 | 0.0 | 72.74 | −25.70 | 2 | 2 | 0 | 0 |
| −2.95 | 2.1 | 0.0 | 0.0 | 0.0 | 71.44 | −25.78 | 2 | 2 | 0 | 0 |
| −2.90 | 2.1 | 0.0 | 0.0 | 0.0 | 70.24 | −25.85 | 2 | 2 | 0 | 0 |
| −2.85 | 2.1 | 0.0 | 0.0 | 0.0 | 69.10 | −25.89 | 2 | 2 | 0 | 0 |
| . | . | . | . | . | . | . | . | . | . | . |
| . | . | . | . | . | . | . | . | . | . | . |
| . | . | . | . | . | . | . | . | . | . | . |
| −0.15 | 1.5 | −8.6 | 0.0 | 0.0 | −5.78 | −26.28 | 2 | 2 | 0 | 0 |
| −0.10 | 1.3 | −10.4 | 0.0 | 0.0 | −6.30 | −24.10 | 2 | 2 | 1 | 1 |
| −0.05 | 0.8 | −11.0 | 0.0 | 0.0 | −6.01 | −20.18 | 2 | 2 | 1 | 1 |
| 0.00 | 0.3 | −9.9 | 104.8 | 0.6 | −4.99 | −14.77 | 1 | 1 | 1 | 1 |
| 0.05 | −0.3 | −7.7 | 104.8 | 0.6 | −3.58 | −9.01 | 1 | 1 | 1 | 1 |
| . | . | . | . | . | . | . | . | . | . | . |
| . | . | . | . | . | . | . | . | . | . | . |
| . | . | . | . | . | . | . | . | . | . | . |
| 1.85 | 0.1 | −2.7 | 0.0 | 0.0 | −2.89 | −0.22 | 1 | 1 | 1 | 1 |
| 1.90 | 0.0 | −2.2 | 0.0 | 0.0 | −2.94 | −0.35 | 1 | 1 | 1 | 1 |
| 1.95 | −0.2 | −1.5 | 0.0 | 0.0 | −2.96 | −0.43 | 1 | 1 | 1 | 1 |
| 2.00 | −0.3 | −0.9 | 0.0 | 0.0 | −2.98 | −0.46 | 1 | 1 | 1 | 1 |

### 3. Pseudo Code for Sink Rate Computations

The pseudo code for the sink rate computations depicted in FIGS. 2A-2D is as follows:

| | | |
|---|---|---|
| Parameters | 777-200 | 777-300 |
| K_pit_att_td | 5.30 deg | 4.15 deg |
| L1_ra_mg | 63.0 ft | 80.5 ft |
| L2_ad_mg | 87.5 ft | 105.0 ft |
| Kwnsq | 9.0 (rad/sec)² | 9.0 (rad/sec)² |
| K2zwn | 6.0 rad/sec | 6.0 rad/sec |

CCC 1) Compute the Pitch Attitude Radio Altimeter Correction Term

pit_att_racorr = L1_ra_mg * (pit_att_ad − K_pit_att_td) / 57.2958

CCC 2) Compute the Unfiltered Gear Altitude

gear_alt_unf = radio_alt − pit_att_racorr

CCC 3) Compute the Gear Altitude Complementary Filter Front End
if ( comp_filt_ic = TRUE )

gear_alt_err = 0.0
r_int1 = 0.0
int2_term = 0.0

else

gear_alt_err = gear_alt_unf − gear_alt_fil
r_int1 = gear_alt_err * Kwnsq + (vert_acc_ad * 32.174)
int2_term = gear_alt_err * K2zwn

endif
CCC 4) Compute the Gear Altitude Complementary Filter First Integrator
if { comp_filt_ic = TRUE )

v_spd_fps = vert_spd_ad / 60.
q_int1 = v_spd_fps / 2.0
q_int1_prev = q_int1
c_int1 = q_int1 * 2.0

else

q_int1 = .025 * r_int1 + q_int1_prev
c_int1 = q_int1 + q_int1_prev
q_int1_prev = q_int1

endif
CCC 5) Compute the Gear Altitude Complementary Filter Middle Section

gear_alt_rt_unf = c_int1 − L2_ad_mg * pit_rate_ad / 57.2958
r_int2 = gear_alt_rt_unf + int2_term

CCC 6) Compute the Gear Altitude Complementary Filter Second
Integrator
if ( comp_filt_ic = TRUE )

q_int2 = gear_alt_unf / 2.0 + v_spd_fps * .75 * .05
q_int2_prev = q_int2
c_int2 = gear_alt_unf + v_spd_fps * .05

else

q_int2 = .025 * r_int2 + q_int2_prev
c_int2 = q_int2 + q_int2_prev
q_int2_prev = q_int2

endif

gear_alt_fil = c_int2

CCC 7) Compute the Gear Altitude Rate Filter Output from the Final Lag
Filter
if ( comp_filt_ic = TRUE )

q_lag1 = gear_alt_rt_unf / 2.0
q_lag1_prev = q_lag1
c_lag1 = gear_alt_rt_unf

else

q_lag1 = .09090909 * gear_alt_rt_unf − (−.81818181) *
q_lag1_prev
c_lag1 = q_lag1 + q_lag1_prev
q_lag1_prev = q_lag1

endif

gear_alt_rt_fil = c_int1

1. A method for reporting data concerning a landing of an aircraft, comprising:
receiving a respective set of data samples for each of a set of flight parameters, the data samples in each data sample set being received at different times during a time interval that starts prior to and ends subsequent to touchdown of said aircraft;
deriving a series of main gear sink rate values from data sample sets of a subset of said flight parameters during said time interval, each main gear sink rate value being a function of the data samples for said subset of said flight parameters corresponding to a respective time;
determining whether a trigger event has occurred;
collecting at least said data sample sets of said subset of said flight parameters acquired during said time interval and said main gear sink rate values derived during said time interval in response to occurrence of said trigger event; and
sending said collected data sample sets and main gear sink rate values to an output device in a report format.

2. The method as recited in claim 1, wherein said trigger event is touchdown of said aircraft.

3. The method as recited in claim 1, wherein said trigger event is that the gross weight of said aircraft at touchdown exceeds a threshold amount.

4. The method as recited in claim 1, wherein said trigger event is that a set of trigger preconditions have been satisfied.

5. The method as recited in claim 4, wherein said set of trigger preconditions are that, at the time of aircraft touchdown, the roll angle and roll rate of said aircraft lie within respective predefined ranges and the current or preceding main gear sink rate value exceeds a threshold amount.

6. The method as recited in claim 4, wherein said set of trigger preconditions are that, at the time of aircraft touchdown, the roll angle and/or roll rate of said aircraft lie outside respective predefined ranges and the current or preceding main gear sink rate value exceeds a threshold amount.

7. The method as recited in claim 1, wherein said deriving step is initiated when said aircraft reaches a predefined radio altitude.

8. The method as recited in claim 1, wherein said subset of said flight parameters comprises vertical acceleration, pitch attitude, pitch attitude rate, and radio altitude.

9. A system for reporting data concerning a landing of an aircraft, comprising an output device and a computer capable of communicating with said output device, said computer being programmed to perform the following operations:
receiving a respective set of data samples for each of a set of flight parameters, the data samples in each data sample set being received at different times during a time interval that starts prior to and ends subsequent to touchdown of said aircraft;
deriving a series of main gear sink rate values from data sample sets of a subset of said flight parameters during said time interval, each main gear sink rate value being a function of the data samples for said subset of said flight parameters corresponding to a respective time;
determining whether a trigger event has occurred;
collecting at least said data sample sets of said subset of said flight parameters acquired during said time interval and said main gear sink rate values derived during said time interval in response to occurrence of said trigger event; and
sending said collected data sample sets and main gear sink rate values to said output device in a report format.

10. The system as recited in claim 9, wherein said trigger event is touchdown of said aircraft.

11. The system as recited in claim 9, wherein said trigger event is that the gross weight of said aircraft at touchdown exceeds a threshold amount.

12. The system as recited in claim 9, wherein said trigger event is that a set of trigger preconditions have been satisfied.

13. The system as recited in claim 12, wherein said set of trigger preconditions are that, at the time of aircraft touchdown, the roll angle and roll rate of said aircraft lie within respective predefined ranges and the current or preceding main gear sink rate value exceeds a threshold amount.

14. The system as recited in claim 12, wherein said set of trigger preconditions are that, at the time of aircraft touchdown, the roll angle and/or roll rate of said aircraft lie outside respective predefined ranges and the current or preceding main gear sink rate value exceeds a threshold amount.

15. The system as recited in claim 9, wherein said deriving step is initiated when said aircraft reaches a predefined radio altitude.

16. The system as recited in claim 9, wherein said subset of said flight parameters comprises vertical acceleration, pitch attitude, pitch attitude rate, and radio altitude.

17. An airplane comprising a computer, a radio altimeter, an air data inertial reference unit (ADIRU), and an output device, said computer being programmed to perform the following operations:
receiving radio altitude data samples from said radio altimeter during a time interval that starts prior to and ends subsequent to touchdown of said aircraft;
receiving vertical acceleration data samples, pitch attitude data samples, and pitch attitude rate data samples from said ADIRU during said time interval;
deriving main gear sink rate values based at least partly on said received data samples during said time interval, each main gear sink rate value being a function of the data samples corresponding to a respective time during said time interval;
determining whether a trigger event has occurred;
collecting at least said received data samples and said derived main gear sink rate values in response to occurrence of said trigger event; and
sending said collected data samples and main gear sink rate values to said output device in a report format.

18. The system as recited in claim 17, wherein said trigger event is that a main landing gear truck has transitioned from a tilted state to a less-tilted state.

19. The system as recited in claim 17, wherein said trigger event is that the gross weight of said aircraft at touchdown exceeds a threshold amount.

20. The system as recited in claim 17, wherein said trigger event is that at aircraft touchdown, the roll angle and roll rate of said aircraft lie within respective predefined ranges and the current or preceding main gear sink rate value exceeds a threshold amount.

21. The system as recited in claim 17, wherein said trigger event is that at aircraft touchdown, the roll angle and roll rate of said aircraft lie outside respective predefined ranges and the current or preceding main gear sink rate value exceeds a threshold amount.
